(19) United States
(12) Patent Application Publication
(10) Pub. No.: US 2008/0155330 A1
(43) Pub. Date: Jun. 26, 2008

(54) METHODS AND APPARATUS FOR DEBUGGING A WORKFLOW PROCESS

(75) Inventors: Adriaan Van Wyk, Strubensvalley (ZA); Natachya Raath, Vanderbijlpark (ZA); Lenz le Roux, Radiokop (ZA); Wynand du Toit, Little Falls (ZA); Ben Fourie, Radiokop (ZA); Schalk de Jager, Weltevreden Park (ZA); Pieter Janson, Centruion (ZA); Olaf Wagner, Issaquah, WA (US)

Correspondence Address: BELL, BOYD & LLOYD, LLP, P.O. Box 1135, CHICAGO, IL, 60690, US

(73) Assignee: SOURCECODE TECHNOLOGY HOLDING, INC., Redmond, WA (US)

(21) Appl. No.: 11/945,878

(22) Filed: Nov. 27, 2007

Related U.S. Application Data
(60) Provisional application No. 60/939,285, filed on May 21, 2007.
(60) Provisional application No. 60/867,344, filed on Nov. 27, 2006.

(51) Int. Cl. G06F 11/36

(52) U.S. Cl. 714/35; 714/E11.21

(57) ABSTRACT

The present disclosure provides methods and apparatuses for debugging a workflow. Using the methods and apparatus herein, users can utilize common debugging constructs such as watch variables, step into/over and call stack. This allows users to visually debug all elements of process design, not just code snippets, at design time before the process is deployed.

### CROSS-REFERENCE TO RELATED APPLICATIONS

The present application claims benefit to U.S. Patent Application No. 60/867,344, METHOD AND APPARATUS FOR CREATING WORK FLOW, filed on Nov. 27, 2006; and U.S. Patent Application No. 60/939,285, METHODS AND APPARATUS FOR DEBUGGING A WORKFLOW PROCESS, filed on May 21, 2007, the entire contents of which are incorporated herein by reference.

### BACKGROUND

A business process is a combination of operational steps or activities that a business undertakes. A business may conduct a high number of business processes throughout the course of a day or year, in order to accomplish the business's goals. An operational step or activity may be any action from the mundane to the complex.

Through the use of technology, businesses can now model their business processes in a graphical nature. What used to be a loosely defined set of procedures can now be formalized into complex business process workflows. The formalized business processes allow managers to understand the bottlenecks of a process, and to redesign the business processes for efficiency.

Business can now also incorporate business process design into their existing technology systems. Instead of providing a simple map of a business process, integration with computer systems allows business process designers to design interactive business processes that drive business workflow. Business process designers can receive data from various sources and perform a wide range of actions on the data directly, and create business processes in an easy to understand visual manner.

Businesses create workflows as a part of business process design to assist in managing their internal operations. Business processes allow users to represent the current state of their business operations in a graphical manner. Users can also simulate new business operations through the use of business processes.

Business process design in organizations is typically done with tools that are either business user or developer focused. The developer focused tools will typically allow a developer to write code and scripts to provide granular control over the process design. Many times, this ability to write a snippet of code or provide a few lines of script is the extent of developer support that is found. When the tools do provide additional support for compiled languages they rely on the development tools for those compiled languages. Debugging the process design is subsequently limited to the code snippet and not the overall process design.

### SUMMARY

The present disclosure provides methods and apparatuses for debugging a workflow. Using the methods and apparatus herein, users can utilize common debugging constructs such as watch variables, step into/over and call stack. This allows users to visually debug all elements of process design, not just code snippets, at design time before the process is deployed.

Additional features and advantages are described herein, and will be apparent from, the following Detailed Description and the figures.

### BRIEF DESCRIPTION OF THE FIGURES

FIG. 1 is a high level block diagram of an example workflow debugging system.

FIG. 2 is a more detailed block diagram showing one example of a client device.

FIG. 3 is a more detailed block diagram showing one example of a server.

FIG. 4 is a flowchart of an example process for automatically attaching a breakpoint to a workflow.

FIG. 5 is a flowchart of an example process for manually attaching a breakpoint to a workflow.

FIG. 6 is a screenshot of an example breakpoint on an activity.

FIG. 7 is a screenshot of an example breakpoint on an event.

FIG. 8 is a screenshot of an example breakpoint on a line.

FIG. 9 is a screenshot of an example debugging across multiple technologies.

### DETAILED DESCRIPTION

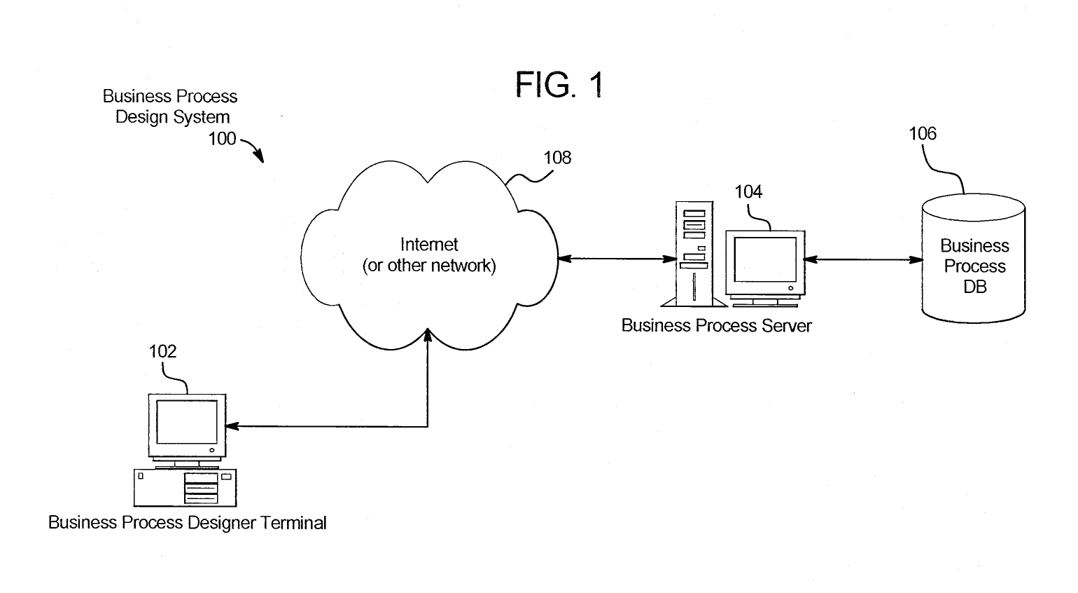

The present system is most readily realized in a network communications system. A high level block diagram of an exemplary network communications system 100 is illustrated in FIG. 1. The illustrated system 100 includes one or more business process designer terminals 102, one or more business process servers 104, and one or more business process databases 106. Each of these devices may communicate with each other via a connection to one or more communications channels 108 such as the Internet or some other data network, including, but not limited to, any suitable wide area network or local area network. It will be appreciated that any of the devices described herein may be directly connected to each other instead of over a network.

The business process server 104 stores a plurality of files, programs, and/or web pages in one or more business process databases 106 for use by the business process designer terminals 102. The business process database 106 may be connected directly to the business process server 104 or via one or more network connections. The business process database 106 preferably stores business process data.

One business process server 104 may interact with a large number of business process designer terminals 102. Accordingly, each business process server 104 is typically a high end computer with a large storage capacity, one or more fast microprocessors, and one or more high speed network connections. Conversely, relative to a typical business process server 104, each business process designer terminal 102 typically includes less storage capacity, a single microprocessor, and a single network connection.

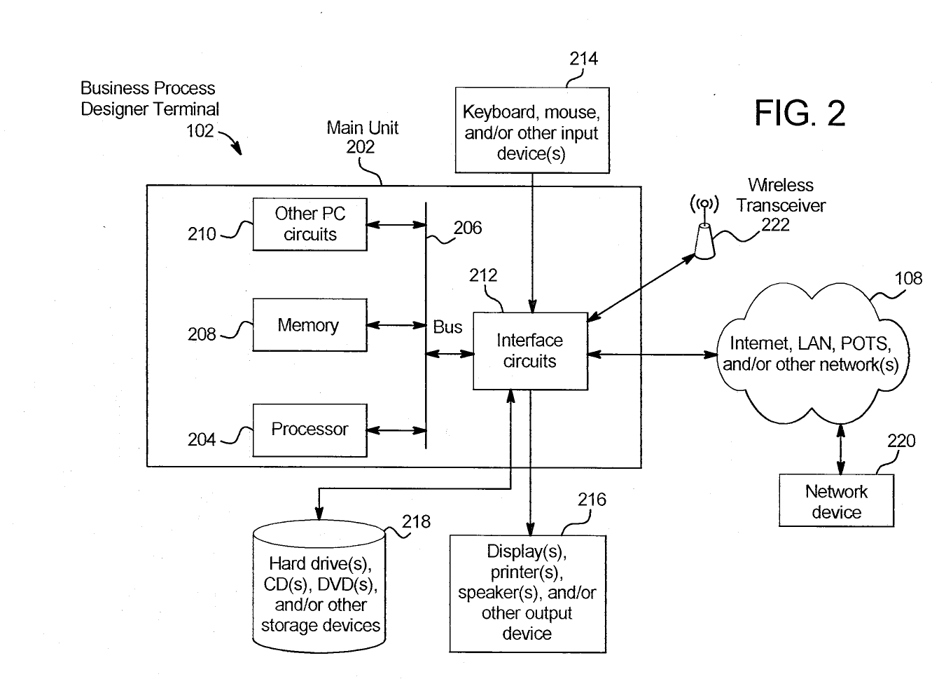

A more detailed block diagram of a business process designer terminal 102 is illustrated in FIG. 2. The business process designer terminal 102 may include a personal computer (PC), a personal digital assistant (PDA), an Internet appliance, a cellular telephone, or any other suitable communication device. The business process designer terminal 102 preferably includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with one or more of the other devices in the system 100 as described below. This program may be executed by the processor 204 in any suitable manner. The memory 208 may also store digital data indicative of documents, files, programs, web pages, etc. retrieved from one or more of the other devices in the system 100 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the business process designer terminal 102. For example, the display 216 may be used to display web pages received from the business process server 104. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the business process designer terminal 102.

The business process designer terminal 102 may also exchange data with other network devices 220 via a connection to the network 112. The network connection may be any type of network connection, such as an Ethernet connection, digital subscriber line (DSL), telephone line, coaxial cable, etc. Users of a business process designer terminal 102 may be required to register with the business process server 104. In such an instance, each user of a business process designer terminal 102, may choose a user identifier (e.g., e-mail address) and a password which may be required for the activation of services. The user identifier and password may be passed across the network 108 using encryption built into the business process designer terminal 102 browser. Alternatively, the user identifier and/or password may be assigned by the business process server 104.

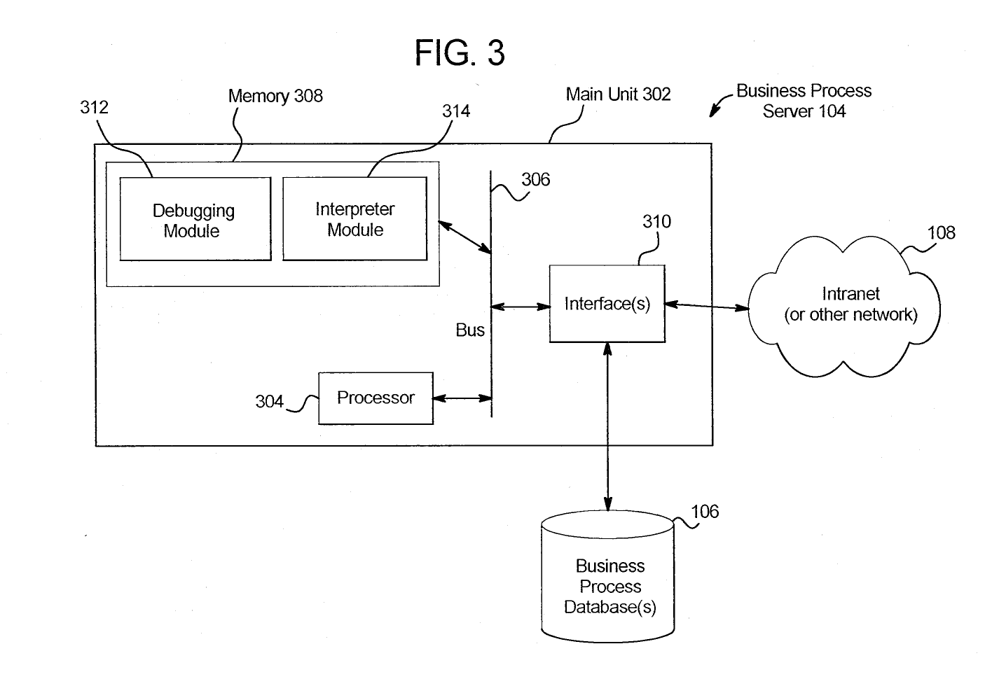

A more detailed block diagram of a business process server 104 is illustrated in FIG. 3. Like the business process designer terminal 102, the main unit 302 in the business process server 104 preferably includes one or more processors 304 electrically coupled by an address/data bus 306 to a memory device 308 and a network interface circuit 310. The network interface circuit 310 may be implemented using any suitable data transceiver, such as an Ethernet transceiver. The processor 304 may be any type of suitable processor, and the memory device 308 preferably includes volatile memory and non-volatile memory. Preferably, the memory device 308 stores a software program that implements all or part of the method described below.

In particular, the memory preferably stores a debugging module 312 and an interpreter module 314. The debugging module 312 may run a business process, set breakpoints in the business process, and save the state of a business process.

The interpreter module 314 may facilitate communication between a Business Process Designer Terminal 102 and Business Process Server 104. The interpreter module 314 may convert client objects into server objects. For example the interpreter module 314 may convert COM objects into serialized objects so that the Business Process Designer Terminal 102 may communicate the state of a process to the Business Process Server 104.

These software modules 312, and 314 may be executed by the processor 304 in a conventional manner. However, some of the acts described in the method below may be performed manually or without the use of the business process server 104. The memory device 308 and/or a separate business process database 106 also store files, programs, web pages, etc. for use by other business process servers 104 or business process designer terminals 102.

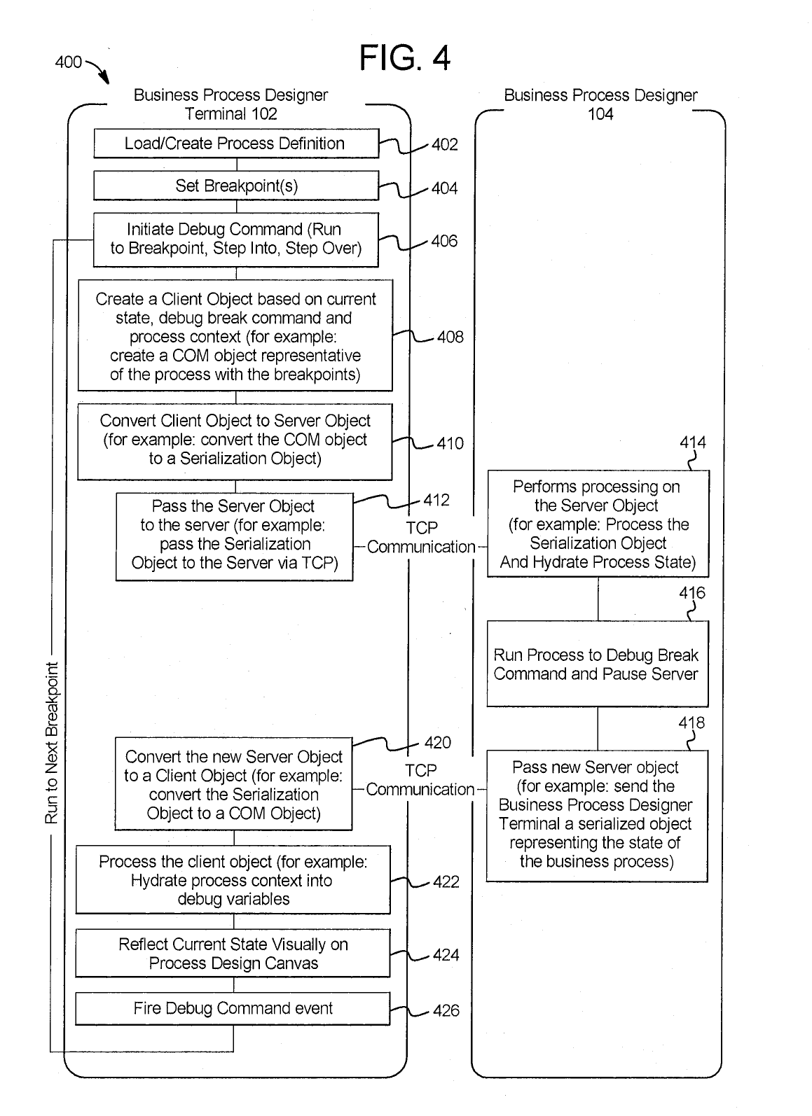

A flowchart of an example process 400 for automatically attaching a break point is shown in FIG. 4. Preferably, the process 400 is embodied in one or more software programs stored in one or more memories and executed by one or more processors. Although the process 400 is described with reference to the flowchart illustrated in FIG. 4, it will be appreciated that many other methods of performing the acts associated with process 400 may be used. For example, the order of many of the acts may be changed, and some of the acts described may be optional.

In this example, the process 400 loads or creates a process definition (block 402) at the Business Process Designer Terminal 102. For example, a business process designer may load an already existing business process or create a new business process on the Business Process Designer Terminal 102. The business process designer may use a graphical business process design software package to create the new process.

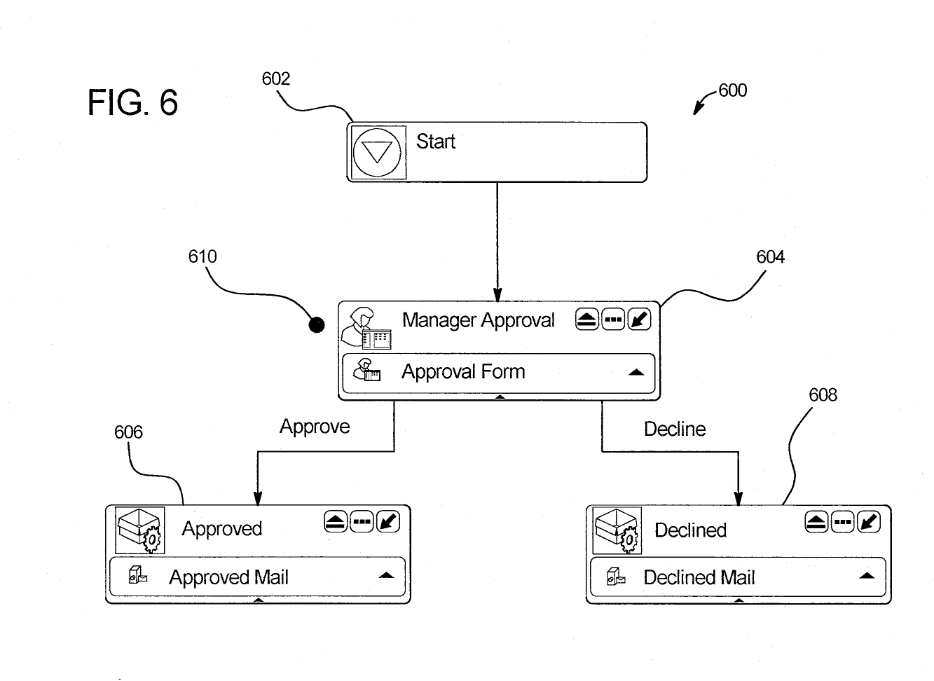

The process 400 then sets a breakpoint or multiple breakpoints 610 (block 404). For example, the user may select a step of the business process and set a breakpoint 610. See the FIGS. 6, 7 and 8 for an example of setting a breakpoint 610.

The process 400 then initiates a debug command (block 406). For example, the user may select from a number of debugging commands. The debugging commands may include run to breakpoint, step into, step over, etc. The Business Process Designer Terminal 102 runs the process based on the debugging command chosen.

The process 400 then creates a client object based on the current state, the debug break command, and the process context (block 408). For example, the Business Process Designer Terminal 102 may create a COM object representative of the process state and the placement of the breakpoints.

The process 400 then converts the client object for transmission to a Business Process Server 104 (block 410). For example, the Business Process Designer Terminal 102 may serialize the COM object to create a server object. The server object may be in XML or another format.

The process 400 then passes the server object to the Business Process Server 104 (block 412). For example, the Business Process Designer Terminal 102 may transfer the server object to the Business Process Server 104 via the TCP protocol.

The process 400 then performs processing on the server object (block 414). For example, the Business Process Server 104 may hydrate the server object, running the business process until the state that the server object represents is reached.

The process 400 then continues to run the process to the debug break command (block 416). For example, the Business Process Server 104 may perform processing to execute the steps of the business process until reaching a debug break command.

The process 400 then passes a new server object to the Business Process Designer Terminal 102 (block 418). For example, the Business Process Server 104 may create a new serialized representation of the business process at the debug break command step. The Business Process Server 104 may then transfer the new server object to the Business Process Designer Terminal 102 via the TCP protocol.

The process 400 then converts the new server object to a client object (block 420). For example, the Business Process Designer Terminal 102 may convert the XML document into a COM object.

The process 400 then processes the client object (block 422). For example, the Business Process Designer Terminal 102 may hydrate the COM object and populate the debug variables associated with the business process steps.

The process 400 then reflects the current state visually on the process design canvas (block 424). For example, the Business Process Designer Terminal 102 may cause the graphical business process design software to show the current state of the business process. The current state of the business process may include a current state of the debug variables as well.

The process 400 then fires the debug command event (block 426). For example, if the debug command event was a decision, the Business Process Designer Terminal 102 may cause the decision to be executed.

The process 400 then returns to block 406 for the next breakpoint in the business process. For example, the process 400 then initiates the debug command after firing the last debug command event.

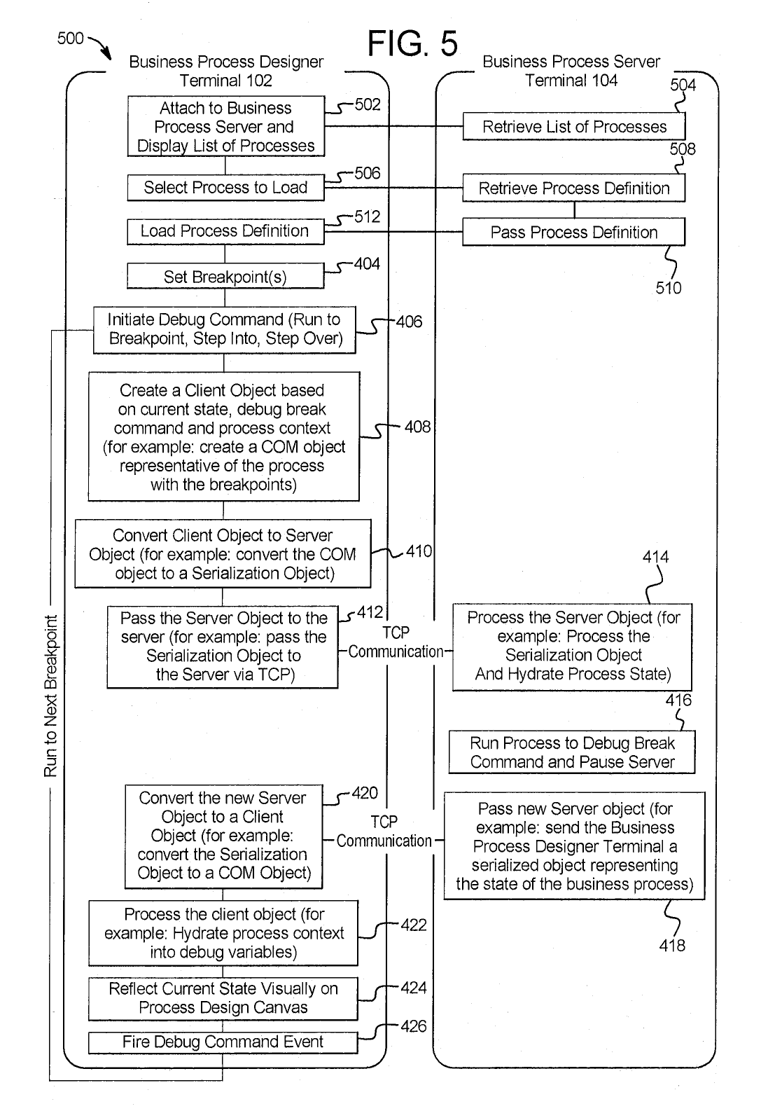

A flowchart of an example process 500 for manually attaching a break point is shown in FIG. 5. Preferably, the process 500 is embodied in one or more software programs stored in one or more memories and executed by one or more processors. Although the process 500 is described with reference to the flowchart illustrated in FIG. 5, it will be appreciated that many other methods of performing the acts associated with process 500 may be used. For example, the order of many of the acts may be changed, and some of the acts described may be optional.

In this example, the process 500 attaches to the Business Process Server 104 and displays a list of processes (block 502). For example, a business process designer may select to determine what processes are currently running on the Business Process Server 104. The Business Process Designer Terminal 102 may then communicate with the Business Process server 104 to retrieve a list of running processes (block 504).

The process 500 then selects a process to load (block 504). For example, from the list of running processes, the business process designer may select a certain process to debug.

The process 500 then retrieves the process definition (block 506). For example, the Business Process Designer Terminal 102 may request the business process definition, of the selected business process, from the Business Process Server 104.

The process 500 then passes the process definition (block 508). For example, the Business Process Server 104 may transmit the business process definition to the Business Process Designer Terminal 102 via the internet or other network 108.

The process 500 then loads the process definition (block 510). For example, the Business Process Designer Terminal 102 may load the process definition into graphical business process designer software.

The remaining processes of process 500 are substantially similar to those described above in relation to FIG. 4.

A screenshot of an example breakpoint on an activity 600 is presented in FIG. 6. Although the example breakpoint on an activity 600 is described in reference FIG. 6, it will be appreciated that many other configurations are possible. For example, elements could be in different locations, elements could have different names, and elements could have different graphical representations.

A workflow process may have a starting indicator 602. For example, a graphical representation may be displayed indicating that the workflow process begins at the starting indicator 602. A workflow process may have activities. For example, the activities may be Manager Approval 604, Approved 606, Declined 608 etc. A user may insert a breakpoint 610. For example, the user may select an activity and press F9, the system would note that user entered a breakpoint on the activity. The Business Process Designer Terminal 102 may display a breakpoint 610 indicator next to the graphical representation of the activity. For example, in FIG. 6, a breakpoint 610 indicator appears next to the Manager Approval activity 604.

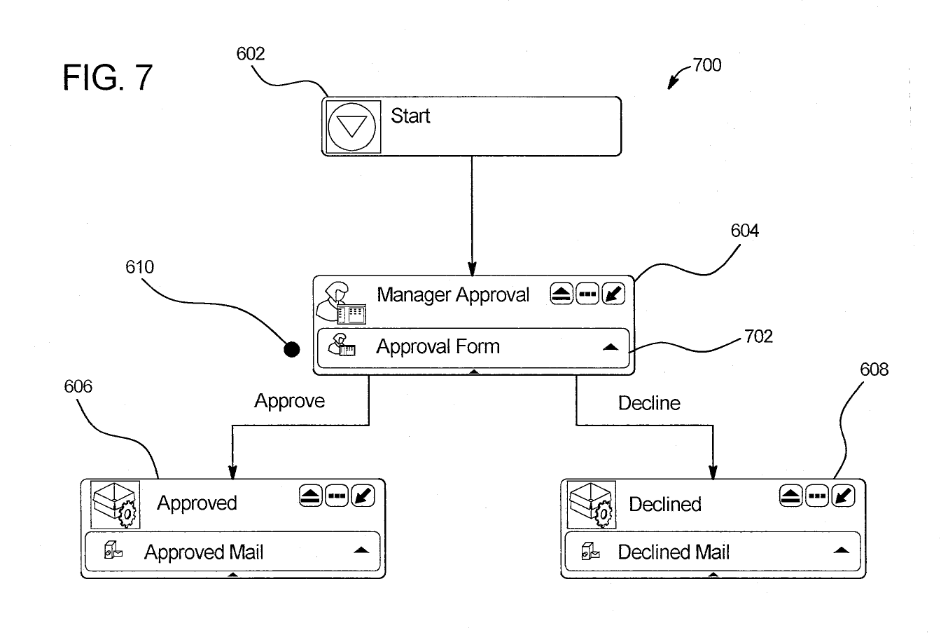

A screenshot of an example breakpoint on an event 700 is presented in FIG. 7. Although the example breakpoint on an event 700 is described in reference FIG. 7, it will be appreciated that many other configurations are possible. For example, elements could be in different locations, elements could have different names, and elements could have different graphical representations.

An activity may have an associated event. For example, the Manager Approval 604 activity, may have an approval form event 702. The user may associate a breakpoint 610 with an event. For example, the user may chose to place a breakpoint at an approval form event 702. The Business Process Designer Terminal 102 may display a breakpoint 610 indicator next to the graphical representation of the event. For example, in FIG. 7, a breakpoint 610 indicator appears next to the approval form event 702.

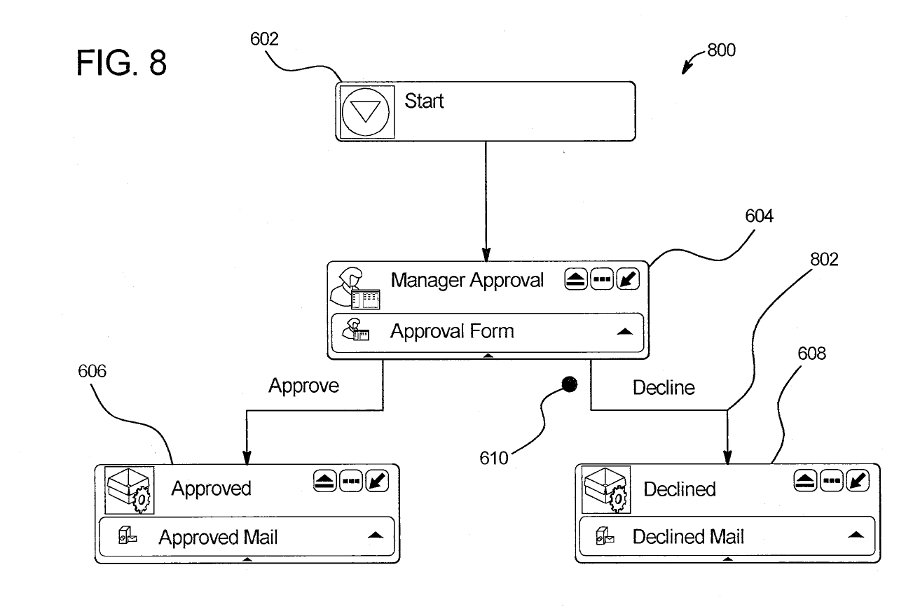

A screenshot of an example breakpoint on a line 600 is presented in FIG. 8. Although the example breakpoint on a line 600 is described in reference FIG. 8, it will be appreciated that many other configurations are possible. For example, elements could be in different locations, elements could have different names, and elements could have different graphical representations.

An activity may have an associated line. For example, the Manager Approval 604 activity, may have a decline line 602. The user may associate a breakpoint 610 with a line. For example, the user may chose to place a breakpoint at a decline line 802. The Business Process Designer Terminal 102 may display a breakpoint 610 indicator next to the graphical representation of the line. For example, in FIG. 8, a breakpoint 610 indicator appears next to decline line 802.

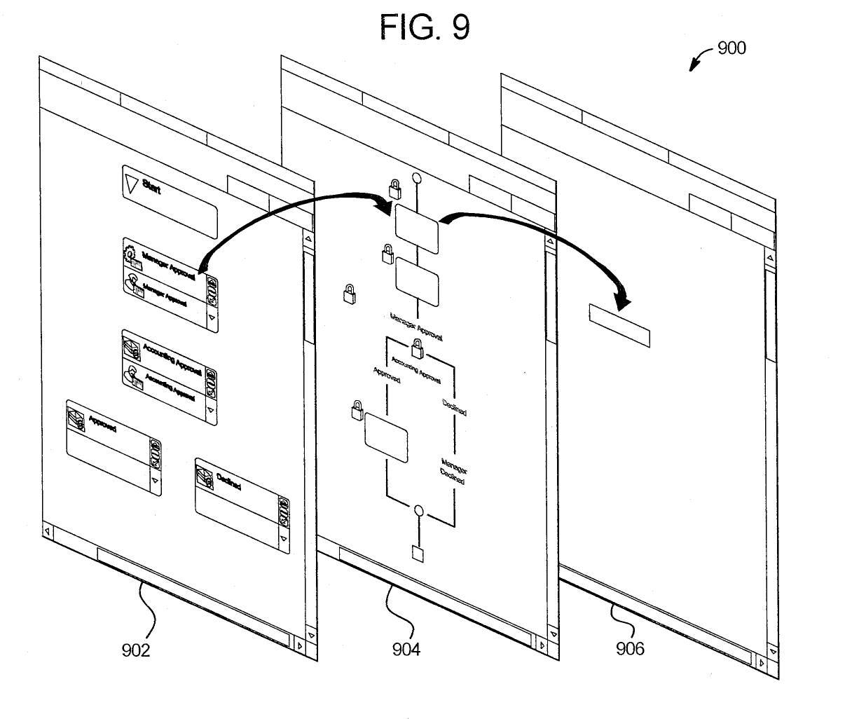

A screenshot of an example debugging across multiple technologies 900 is presented in FIG. 9. Although the example debugging across multiple technologies is described in reference FIG. 9, it will be appreciated that many other configurations are possible. For example, elements could be in different locations, elements could have different names, and elements could have different graphical representations.

A user may wish to debug a workflow process across several technologies. For example, the user may wish to begin with a graphical representation of the workflow process 902. Then the business process designer may with to debug a workflow process at the underlying code level 906. The Business Process Designer Terminal 102 may contain an interpreter that enables debugging. For example, the interpreter may translate a visual representation of a process into a format that the Business Process Server 104 can perform processing on.

Additionally, the Business Process Server 104 may operate in a debug state. For example, in the debug state, the Business Process Server 104 may pass and receive debug commands to the Business Process Designer Terminal 102 in the debug state.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such, changes and modifications be covered by the appended claims.

The invention is claimed as follows:

1. A method for debugging a workflow process, the method comprising:
loading a client workflow process, wherein the client workflow process is located on a client machine;
setting a break point in the client workflow process;
setting a debug command for executing the workflow process;
creating a first client object based on the break point, the debug command and a first process state associated with the workflow process;
converting the first client object into a first server object;
transmitting the first server object from the client machine to a server;
processing the first server object on the server to create a second server object executing the workflow process until the break point is reached;
creating a second server object based on a second process state associated with the workflow process;
transmitting the second server object from the server to the client machine;
converting the second server object into a second client object;
processing the second client object on the client machine to determine a debug variable; and
displaying the debug variable.

2. The method of claim 1, wherein the debug command is one of the group consisting of a run-to-breakpoint command, a step into command and a step over command.

3. The method of claim 1, wherein converting the first client object into the first server object includes serializing the first client object.

4. The method of claim 1, wherein processing the first server object includes hydrating the first server object.

5. The method of claim 1, wherein the second server object is in a markup language.

6. The method of claim 1, including receiving a selection indicative of the workflow process from a list of at least one running process on the server.

7. The method of claim 1, wherein transmitting the first server object is performed via the TCP protocol.

8. A system for debugging a workflow process, the system comprising:
a first processor for:
(a) loading a first workflow process;
(b) setting a break point in the first workflow process;
(c) setting a debug command for executing the workflow process;
(d) creating a first object based on the debug command, the break point and a first process state associated with the workflow process; and
(e) converting a state of the first object from a client state to a server state;
a first transmitter for transmitting the first object, in a server state, from a client machine to a server;
a second processor for:
(a) processing the first object;
(b) executing the workflow process until the break point is reached;
(c) creating a second object based on a second process state associated with the workflow process;
(d) converting a state of the second object from the server state to the client state;
a second transmitter for transmitting the second object from the server to the client machine; and
a display for displaying the debug variable.

9. The system of claim 8, wherein the debug command is one of the group consisting of a run-to-breakpoint command, a step into command and a step over command.

10. The system of claim 8, wherein converting the state of the first object includes serializing the first object.

11. The system of claim 8, wherein processing the first object includes hydrating the first object.

12. The system of claim 8, wherein the server state is associated with a markup language.

13. The system of claim 8, including a receiver for receiving a selection indicative of the workflow process from a list of at least one running process.

14. The system of claim 8, wherein the first transmitter transmits the first object via the TCP protocol.

15. A computer readable medium storing instructions structured to cause a computing device to:
load a first workflow process;
set a break point in the first workflow process;
set a debug command for executing the workflow process;
create a first object based on the debug command, the break point and a first process state associated with the workflow process; and
convert a state of the first object from a client state to a server state;
transmit the first object, in a server state, to a server;
receive a second object from the server;
convert a state of the second object from a server state to a client state;
process the second object to determine a debug variable; and
display the debug variable

16. The computer readable medium of claim 15, wherein the debug command is one of the group consisting of a run-to-breakpoint command, a step into command and a step over command.

17. The computer readable medium of claim 15, wherein the instructions are structured to cause the computing device to convert the state of the first object by serializing the first object.

18. The computer readable medium of claim 15, wherein the instructions are structured to cause the computing device to hydrate the second object.

19. The computer readable medium of claim 15, the server state is associated with a markup language.

20. The computer readable medium of claim 15, wherein the instructions are structured to cause the computing device to receive a selection indicative of the workflow process from a list of at least one running process.

21. The computer readable medium of claim 15, wherein the instructions are structured to cause the computing device to transmit the first object via the TCP protocol.
